(19) United States
(12) Patent Application Publication
(10) Pub. No.: US 2026/0012092 A1
(43) Pub. Date: Jan. 8, 2026

(54) ASYMMETRICAL HYBRID DC-DC CONVERTER

(71) Applicant: EPIC Microsystems Inc., Santa Clara, CA (US)

(72) Inventor: Nien Hui Kung, San Jose, CA (US)

(21) Appl. No.: 19/259,441

(22) Filed: Jul. 3, 2025

Related U.S. Application Data
(60) Provisional application No. 63/667,985, filed on Jul. 5, 2024.

(51) Int. Cl. H02M 3/156; H02M 1/00

(52) U.S. Cl. CPC H02M 3/156; H02M 1/0095

(57) ABSTRACT

Hybrid DC-DC converters are described. One aspect is an electrical circuit configured to perform a DC-DC voltage conversion between an input voltage Vᵢₙ and an output voltage Vₒᵤₜ. The electrical circuit may include a first electrical network that includes seven switching transistors and two flying capacitors. The electrical circuit may further include a second electrical network that includes seven switching transistors and two flying capacitors. In an aspect, the first electrical network and the second electrical network are interconnected at least at each of an input node associated with the input voltage, an output node associated with the output voltage, and a switching node. The electrical circuit may also include an inductor connected between the switching node and the output node. In an aspect, the DC-DC voltage conversion involves a repeated cycle of four distinct switching system states.

This application claims the priority benefit of provisional patent application No. 63/667,985 titled “Multiple Asymmetrical Current Path Hybrid Converter” filed on Jul. 5, 2024, the disclosure of which is incorporated by reference herein in its entirety.

### BACKGROUND

### Technical Field

The systems and methods described herein relate to hybrid electrical circuits that are configured to implement power-efficient, high-voltage DC to DC conversion.

### Background Art

The need for more electrical power in current applications has pushed the design of power converters towards its limits. From a small gadget like a smart watch to the big room of a data center, power conversion is used everywhere. Generally speaking, the main sources of electrical power are the “grid” (110V/60 Hz) and the “battery” (1.2V-18V). In most applications, electrical power needs to be converted from a first voltage level to a second voltage level. For example, 110V/60 Hz AC power sourced from the electrical grid may need to be converted to 5V DC power. With ever-increasing electrical power consumption in our lives, efficient power conversion techniques are important to implement.

Power conversion devices with low conversion efficiency may generate heat due to the associated inefficient power conversion. A smart watch, phone, laptop, tablet, or any other personal computing device running at a temperature of 60 degrees Celsius is not a comfortable gadget for a user. A server room of a data center with an ambient temperature of 40 degrees Celsius is also an uncomfortable environment. For years, power conversion efficiency has been an important feature of the electrical power conversion process, and is especially important in today's day and age.

Electrical power conversion is achieved with electrical converters. Based upon input and output time-dependent current/voltage, there are 4 basic types of converters: AC to AC, AC to DC, DC to DC, and DC to AC. They cover all combinations between alternating current (AC) and constant/direct current (DC) conversion. All battery applications (e.g., mobile phones, tablets, laptops, etc.) use DC to DC converters for inside supply rails and AC to DC converters for charging the respective rechargeable battery from a wall adapter. While a high efficiency power converter helps keep the devices cool, the battery also needs to be charged fast, with more power, from an AC/DC adapter. This requires a high charging current through the adapter cable. The associated heating limits the current through the cable to a maximum of 3 A. However, at such input current, the battery cannot charge fast enough in a short time.

In order to provide high current for charging but low current through the cable of the adapter, the input voltage of the converter (or output voltage of the adapter) needs to be increased. This requires a high input voltage DC/DC converter to supply the internal rails and a high output voltage AC/DC converter to supply the battery charging. A typical such DC/DC converter has 16V-28V/3 A as input voltage, (coming through a cable from a wall adaptor) and 4.5V/10 A-20 A as output (the battery) voltage. One goal of power conversion is to keep handheld devices comfortably cool for a user.

The current generation of AI-based computing systems require a different power delivery system. The microprocessors of an AI-based computing system might need up to 1000 A at 0.6V Such AI-based computing systems may populate data centers. The required power cannot be delivered by a battery; such power is sourced directly from the industrial grid through one or more conversion stages. The first is almost always an AC/DC conversion from 110V AC to 48V DC. From 48V down to 0.6V there are a few conversion stages, done by DC/DC converters. Some of these DC voltage converters are high voltage converters, while some are low voltage converters. Therefore, a high voltage DC/DC converter will satisfy both battery and grid supply systems.

Such converters are important in today's power management systems. Existing power conversion systems such as buck converters are vulnerable to power loss. Buck converters can generate a lot of current but with a power conversion efficiency no greater than 85%. The power efficiency of these systems can be increased by splitting the output into multiple channels (e.g., 100 channels) connected in parallel, with each channel supplying a relatively small amount of current. Because each channel requires an inductor, a printed circuit board (PCB) area occupied by such a system will be prohibitive. Other approaches use charge-pump converters (with a fixed conversion ratio (CR)). Although charge-pump converters can reach 99% efficiency, they are not used for output currents in excess of 2 A. Hence, for the new generation of power-hungry systems, contemporary approaches that use buck converters or charge-pump converters are not suitable.

### SUMMARY

Aspects of the invention are directed to electrical circuits configured to implement power-efficient DC-to-DC power conversion. One aspect includes an electrical circuit configured to perform a DC-DC voltage conversion between an input voltage Vᵢₙ and an output voltage Vₒᵤₜ. The electrical circuit may be comprised of a first electrical network including seven switching transistors and two flying capacitors, and a second electrical network including seven switching transistors and two flying capacitors. The first electrical network and the second electrical network may be interconnected at least at each of an input node associated with the input voltage, an output node associated with the output voltage, and a switching node. In one aspect, the electrical circuit includes an inductor connected between the switching node and the output node.

The DC-DC voltage conversion may involve a repeated cycle of four distinct switching system states, with switching system state being associated with a distinct electric current path through the electrical circuit.

In one aspect, the inductor is included in a current path from the input node to the output node. A direct path between the input node and the output node exists that may include only one or more switching transistors and no other circuit component. Any current path between the input node and the switching node may include at least one flying capacitor. In an aspect, there is at least one switching transistor connected directly to the output node.

In one aspect, the four distinct switching system states are comprised of a first magnetization system state, a demagnetization system state, a second magnetization system state, and the demagnetization system state. At an end of the fourth switching system state, a voltage on each flying capacitor may be equal to a voltage on the flying capacitor at a beginning of the first system state. In an aspect, the equality is established by a feedback control circuit. Each system state may be associated with a combination of each of the switching transistors being either in an on state or an off state.

In one aspect, the input voltage and the output voltage are related as Vᵢₙ≥3Vₒᵤₜ. In another aspect, the input voltage and the output voltage are related as 3Vₒᵤₜ>Vᵢₙ>2Vₒᵤₜ.

A plurality of electrical circuits may be connected in parallel to provide a modified electrical circuit configured to further provide a higher electric current to a load as compared an electric current provided by the electrical circuit.

A transition between any switching system state and a subsequent switching system state may be governed by a clock signal.

A modified electrical circuit that includes at least one switching transistor added to the electrical circuit may be constructed based on the electrical circuit. In this modified electrical circuit, the input voltage and the output voltage may be related as 3Vₒᵤₜ>Vᵢₙ>Vₒᵤₜ.

For the modified electrical circuit, the four switching states are a first magnetization state, a first demagnetization state, a second magnetization state, and a second demagnetization state. In an alternate embodiment of the modified electrical circuit, the associated DC-DC voltage conversion involves a modified repeated cycle of two distinct switching system states. This modified repeated cycle may include a magnetization state and a demagnetization state.

One embodiment includes an electrical circuit configured to perform a DC-DC voltage conversion between an input voltage Vᵢₙ and an output voltage Vₒᵤₜ. The electrical circuit may include a first electrical network including seven switching transistors and two flying capacitors, and a second electrical network including seven switching transistors and two flying capacitors. The first electrical network and the second electrical network may be interconnected at least at each of an input node associated with the input voltage, an output node associated with the output voltage, and a switching node. The electrical circuit may include an inductor connected between the switching node and the output node.

The DC-DC voltage conversion may involve a repeated cycle of two distinct switching system states, with each switching system state being associated with a distinct electric current path through the electrical circuit. In an aspect, the switching states are a magnetization state and a demagnetization state. Specifically, the switching states are a first magnetization state and a second magnetization state. A modified electrical circuit that may include at least one switching transistor added to the electrical circuit.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a circuit diagram of a hybrid DC-DC converter.

FIG. 2 is a timing diagram depicting a plurality of electrical signals associated with an operation of a hybrid DC-DC converter.

FIG. 3 is a circuit diagram of a hybrid DC-DC converter depicting a magnetization state.

FIG. 4 is a circuit diagram of a hybrid DC-DC converter depicting a demagnetization state.

FIG. 5 is a circuit diagram of a hybrid DC-DC converter depicting a magnetization state.

FIGS. 6A-6C are state flow diagrams depicting switching system state transitions associated with an operation of a hybrid DC-DC converter.

FIG. 7 is a circuit diagram of a hybrid DC-DC converter.

FIG. 8 is a circuit diagram of a hybrid DC-DC converter.

FIG. 9 is a circuit diagram of a hybrid DC-DC converter.

FIG. 10 is a circuit diagram of a hybrid DC-DC converter.

FIG. 11 is a circuit diagram depicting a pair of parallel-connected hybrid DC-DC converters.

FIG. 12 is a state flow diagram depicting switching system state transitions associated with an operation of a hybrid DC-DC converter.

FIG. 13 is a state flow diagram depicting switching system state transitions associated with an operation of a hybrid DC-DC converter.

FIG. 14 is a state flow diagram depicting switching system state transitions associated with an operation of a hybrid DC-DC converter.

FIG. 15 is a state flow diagram depicting switching system state transitions associated with an operation of a hybrid DC-DC converter.

FIG. 16 is a state flow diagram depicting switching system state transitions associated with an operation of a hybrid DC-DC converter.

FIG. 17 is a state flow diagram depicting switching system state transitions associated with an operation of a hybrid DC-DC converter.

FIG. 18 is a state flow diagram depicting switching system state transitions associated with an operation of a hybrid DC-DC converter.

FIG. 19 is a circuit diagram of a hybrid DC-DC converter.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random-access memory (RAM) device, a read-only memory (ROM) device, an erasable programmable read-only memory (EPROM or Flash memory) device, a portable compact disc read-only memory (CDROM), an optical storage device, a magnetic storage device, and any other storage medium now known or hereafter discovered. Computer program code for carrying out operations of the present disclosure may be written in any combination of one or more programming languages. Such code may be compiled from source code to computer-readable assembly language or machine code suitable for the device or computer on which the code can be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which includes one or more executable instructions for implementing the specified logical function(s). It is also noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

Aspects of the systems and methods described herein are related to a hybrid, high-voltage DC-to-DC converter with increased efficiency. Unlike a traditional buck converter, with 2 high voltage FETs, where the output current closes through a single path (either from Vᵢₙ or from PGND), the hybrid DC-DC converters disclosed herein use multiple, low-voltage, stacked field-effect transistors (FETs) and multiple current paths through an inductor. This functionality is achieved with a specific switching sequence. This switching sequence reduces the power loss and increases the efficiency of the hybrid DC-DC converter.

To satisfy an even higher input voltage requirement, the circuit topology can be extended to multiple current paths closing to a single inductor. One aspect includes 2 circuits/networks with 7 low-voltage FETs each, one current path through the inductor, and two current paths closing through one or more flying capacitors included in the circuit topology. The input voltage should satisfy the condition Vᵢₙ≥3Vₒᵤₜ.

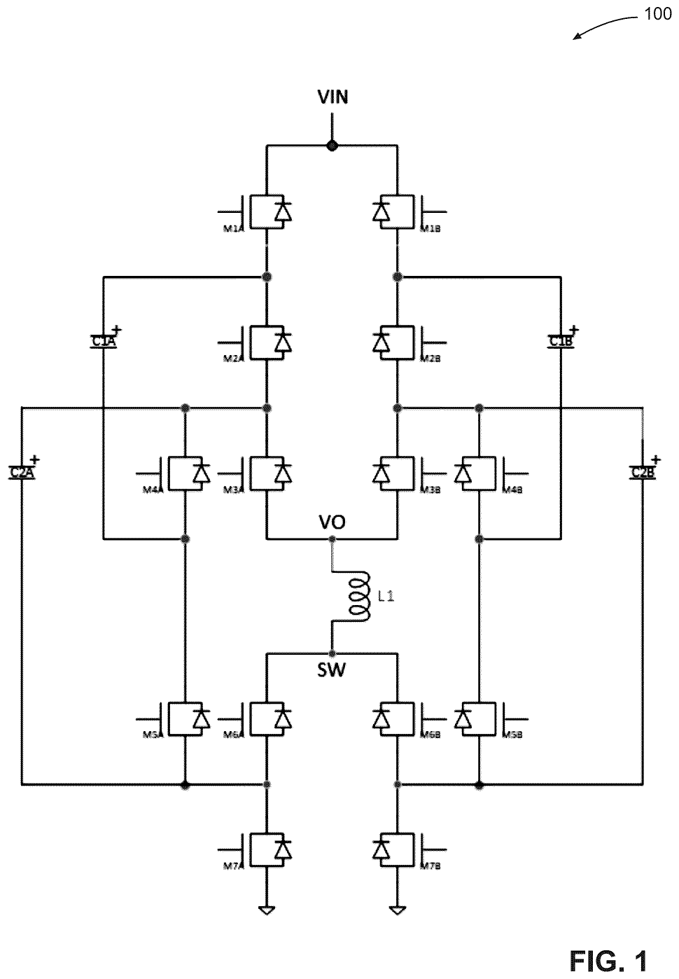

FIG. 1 is a circuit diagram of a hybrid DC-DC converter 100. As depicted, the hybrid DC-DC converter 100 includes an input node associated with an input voltage Vᵢₙ, an output node associated with an output voltage Vₒᵤₜ, and a switching node associated with a voltage V_{LX}. As depicted, hybrid DC-DC converter 100 includes the following components:
M1A-M7A and M1B-M7B are power NFETs (e.g., power switches).
C1A-C2A and C1B-C2B are flying capacitors.
L1 is an inductor, connected between V_{LX} and Vₒᵤₜ.
Cₒᵤₜ is an output capacitor, connected between Vₒᵤₜ and a ground node, PGND (not depicted in FIG. 1).
An electrical load is connected between Vₒᵤₜ and PGND (not shown in FIG. 1). This electrical load may be any combination of a microprocessor, a resistor, a current source, etc.

In an aspect, components M1A-M7A, C1A, and C2A are included in a first electrical network. Components M1B-M7B, C1B and C2B may be included in a second electrical network. The first and second electrical networks may be connected at the input node, the output node, and the switching node, as depicted in FIG. 1. In general, the switching transistors described herein may be any kind of power switch, such as NFETs, PFETs, bipolar switches, thyristors, triacs, gallium nitride (GaN) devices, etc. As depicted, hybrid DC-DC converter 100 includes inductor L1; this inductor is interchangeably referred to herein as “inductor L”.

In an aspect, the first electrical network and the second electrical network are interconnected at least at each of an input node associated with the input voltage, an output node associated with the output voltage, and a switching node SW, associated with a switching voltage V_{LX}.

In an aspect, an operation of hybrid DC-DC converter is associated with the following properties:
There is an inductor (i.e., inductor L) in a current path from Vᵢₙ to Vₒᵤₜ
There exists a direct path (only through switching transistors) between Vₒᵤₜ and Vᵢₙ.
Any path between V_{LX} and Vᵢₙ includes at least one flying capacitor.
There is at least 1 power switch (i.e., switching transistor) connected directly to Vₒᵤₜ.

During operation of hybrid DC-DC converter 100, each of switching transistors M1A-M7A and M1B-M7B is either in an ON state or an OFF state, following a certain pattern/cycle. A cycle is determined by 4 switching system states, with each switching system data being determined by a switching state (i.e., ON/conducting state or OFF/non-conducting state) of each of switching transistors M1A-M7A and M1B-M7B. Each system state is associated with a specific combination of switching transistors M1A-M7A and M1B-M7B each being in an on (conducting) state or an off (non-conducting) state. A switching system state is either initiated by a clock signal and terminated by the falling edge of the T_{ON} signal, or, initiated by the falling edge of the T_{ON} signal and terminated by the clock signal. Both signals, clock, and T_{ON}, are controlled by a feedback loop which regulates the output voltage Vₒᵤₜ.

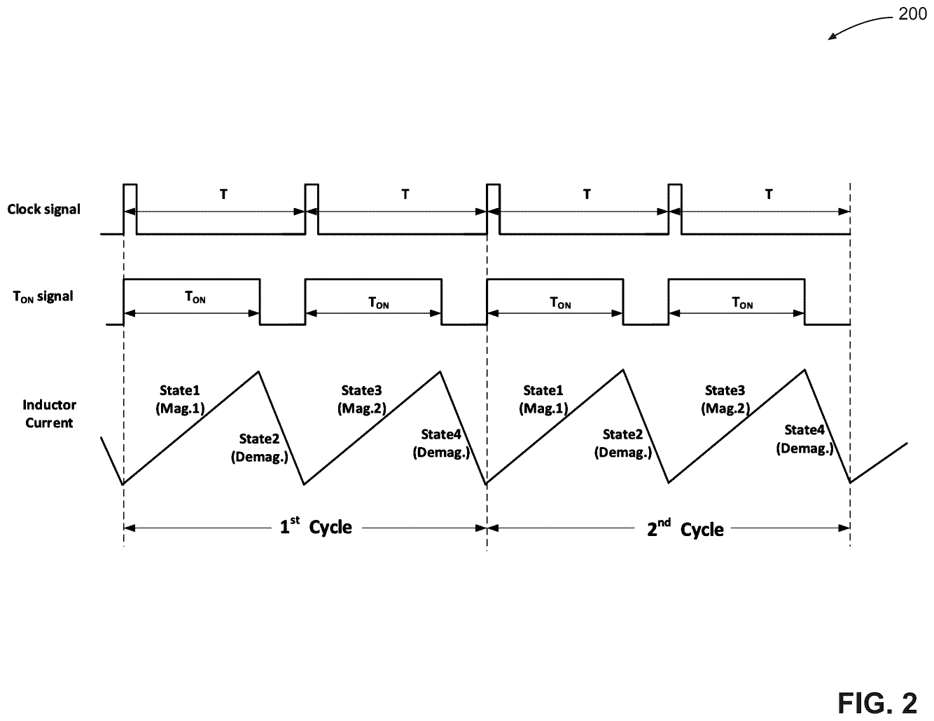

FIG. 2 is a timing diagram 200 depicting a plurality of electrical signals associated with an operation of hybrid DC-DC converter 100. Timing diagram 200 depicts electrical signal waveforms associated with the four distinct switching system states. A switching system state is either initiated by a clock signal and terminated by the falling edge of an associated T_{ON} signal, or, initiated by a falling edge of the T_{ON} signal and terminated by the clock signal. Both signals, clock (clk) and T_{ON}, are controlled by a feedback loop which regulates the output voltage. Timing diagram 200 also depicts a current waveform representing inductor current through inductor L versus time. As shown in the inductor current waveform, there are four distinct switching system states:
A first magnetization state (Magnetization1, or Mag1),
A demagnetization state (Demagnetization, or Demag),
A second magnetization state (Magnetization2, or Mag 2),
The demagnetization state (Demagnetization, or Demag).

A full sequence of the six switching system states (i.e., Mag1 Demag, Mag2, and Demag) constitutes one switching cycle. In one aspect, the demagnetization state may be the same for each demagnetization state in the switching cycle, and denoted by “Demag”.

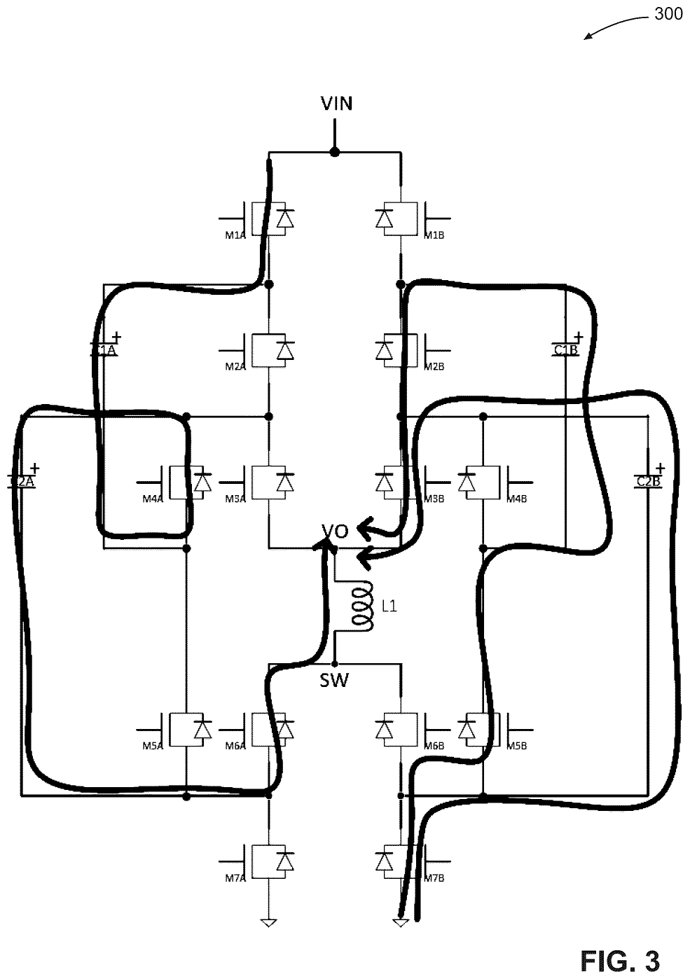

FIG. 3 is a circuit diagram of hybrid DC-DC converter 100 depicting a magnetization state 300. Magnetization state 300 is a switching system state (State 1) that may be associated with magnetization state Mag1, of hybrid DC-DC converter 100. In this magnetization state, the states of the switching transistors are:
ON: M1A, M4A, M6A, M2B, M3B, M5B, M7B
OFF: M2A, M3A, M5A, M7A, M1B, M4B, M6B

As a result of this configuration of ON/OFF switches and considering that the voltages on each of the flying capacitors are near Vₒᵤₜ, the voltage on the inductor is:

$${V}_{L} = ( {V}_{i n} - 3 {V}_{out} ) .$$

Because Vᵢₙ≥3Vₒᵤₜ, such a voltage is positive, and the inductor is magnetized. Hence, this State 1 is referred to as a “Magnetization1” state, or “Mag1”.

During the Mag1 switching system state (State 1), three distinct electrical current paths for electrical currents flowing in hybrid DC-DC converter 100 can be identified:

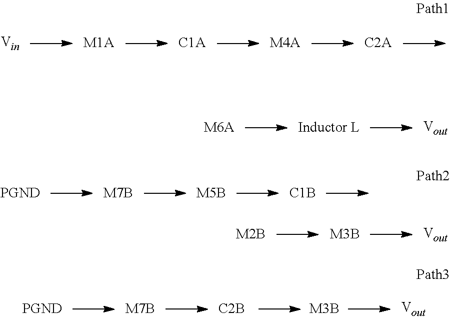

The electrical currents from these three electrical current paths gather into a “Multi Current Path” towards Vₒᵤₜ. Of these, one electrical current path closes through the inductor L and the other two paths go directly to Vₒᵤₜ. A difference from a traditional buck converter is that the second and third paths (i.e., Path2 and Path3) do not exist for a traditional buck converter. This is one of the reasons that hybrid DC-DC converter 100 has better efficiency as compared to a traditional buck converter.

During this Magnetization1 (Mag 1) phase of the inductor L, the flying capacitors change their states as well:
CIA is charged with ΔV₁ by a fraction of the inductor current I_{L},
C2A is charged with ΔV₂ by a fraction of the inductor current I_{L},
C1B is discharged with ΔV₁ by I_{CP}_{₁},
C2B is discharged with ΔV₂ by I_{CP}_{₂}

After the T_{ON} pulse elapsed the system changes the state. It goes to the next switching system state—State 2.

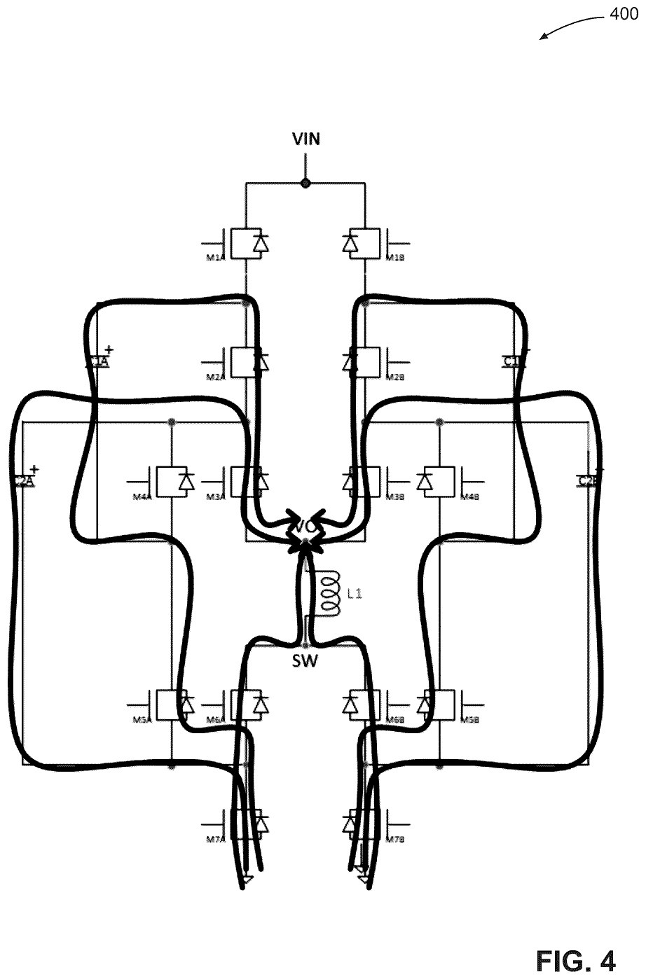

FIG. 4 is a circuit diagram of hybrid DC-DC converter 100 depicting a demagnetization state 400. Demagnetization state 400 is a switching system state (State 2) that may be associated with demagnetization state Demag. In this demagnetization state, the states of the switching transistors are:
ON: M6A, M7A, M6B, M7B. (Options: M2A, M3A, M5A, M2B, M3B, M5B)
OFF: M1A, M4A, M1B, M4B.

The inductor voltage is:

$${V}_{L} = - {V}_{out} .$$

Because of the negative voltage, the inductor is demagnetized. Hence, this switching system state, “State 2”, is called a demagnetization state, or “Demag”.

During the Demag switching system state, at least two distinct electrical current paths for electrical currents flowing in hybrid DC-DC converter 100 can be identified:

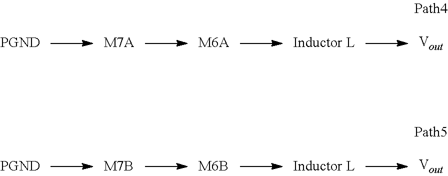

Path4A (Same as Path 7, described subsequently):

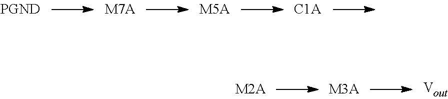

Path5A (Same as Path 8, described subsequently):

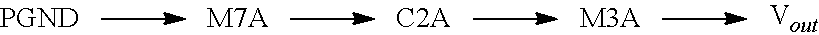

Path4B (Same as Path 2): PGND→M7B→M5B→C1B→M2B→M3B→Vₒᵤₜ
Path5B (Same as Path 3): PGND→M7B→C2B→M4B→Vₒᵤₜ

During this Demag phase, the flying capacitors C1A-C2A and C1B-C2B can be operated to keep their states. There is no current crossing these flying capacitors, so they maintain their respective voltages from the end of State 1. On the other hand, the flying capacitors can be operated to discharge to Vₒᵤₜ if Path5A, 5B, 6A, and 6B are ON.

When the next clock pulse arrives, the system goes into State 3, which is the next switching system state.

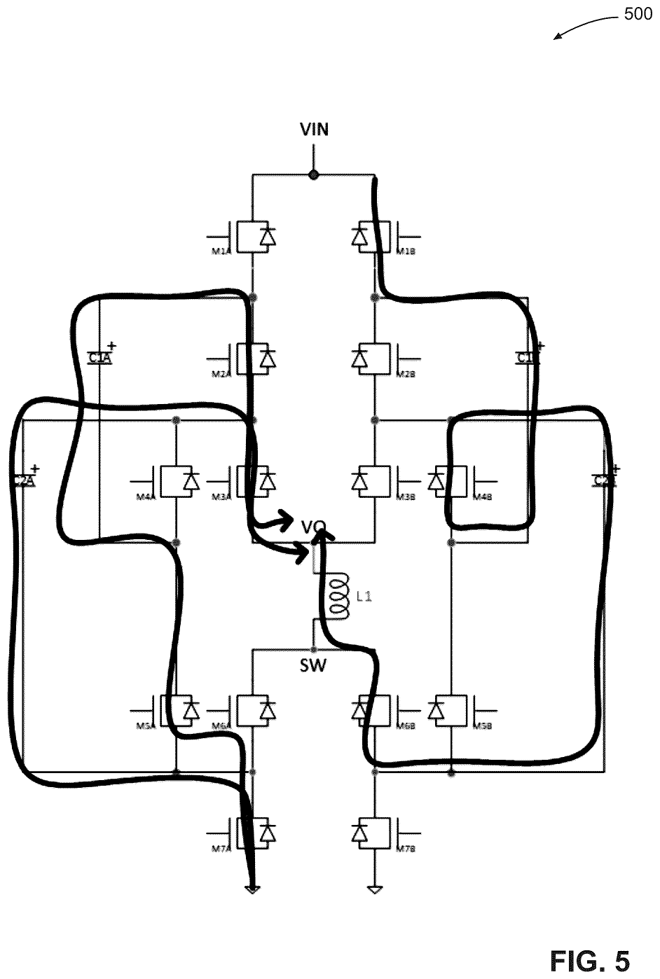

FIG. 5 is a circuit diagram of hybrid DC-DC converter 100 depicting a magnetization state 500. Magnetization state 500 is a switching system state (State 3) that may be associated with magnetization state Mag2. In an aspect, the Mag2 state is a magnetization state, similar to State1 just mirrored on a vertical axis associated with hybrid DC-DC converter 100 in terms of switch states. In this magnetization state, the states of the switching transistors are:
ON: M2A, M3A, M5A, M7A, M1B, M4B, M6B
OFF: MIA, M4A, M6A, M2B, M3B, M5B, M7B

During the Mag2 switching system state, three distinct electrical current paths for electrical currents flowing in hybrid DC-DC converter 100 can be identified:

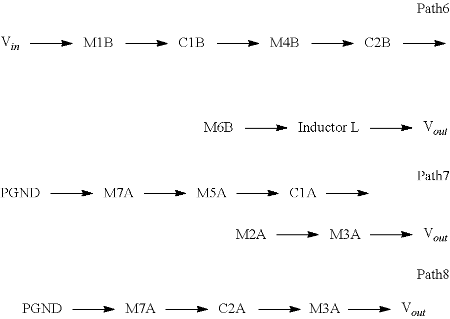

During this Mag2 phase of the inductor L, the flying capacitors change their states as well:
C1B is charged with ΔV1 by a fraction of the inductor current I_{L}_{₂}.
C2B is charged with ΔV2 by a fraction of the inductor current I_{L}_{₂}.
C1A is discharged with ΔV1 by I_{CP}_{₃}
C2A is discharged with ΔV2 by I_{CP}_{₄}

The falling edge of the T_{ON} pulse triggers the end of State 3 and the start of State 4. In an aspect, State 4 is a demagnetization state, that is the same as the Demag State 2. During State 4, the inductor is demagnetized.

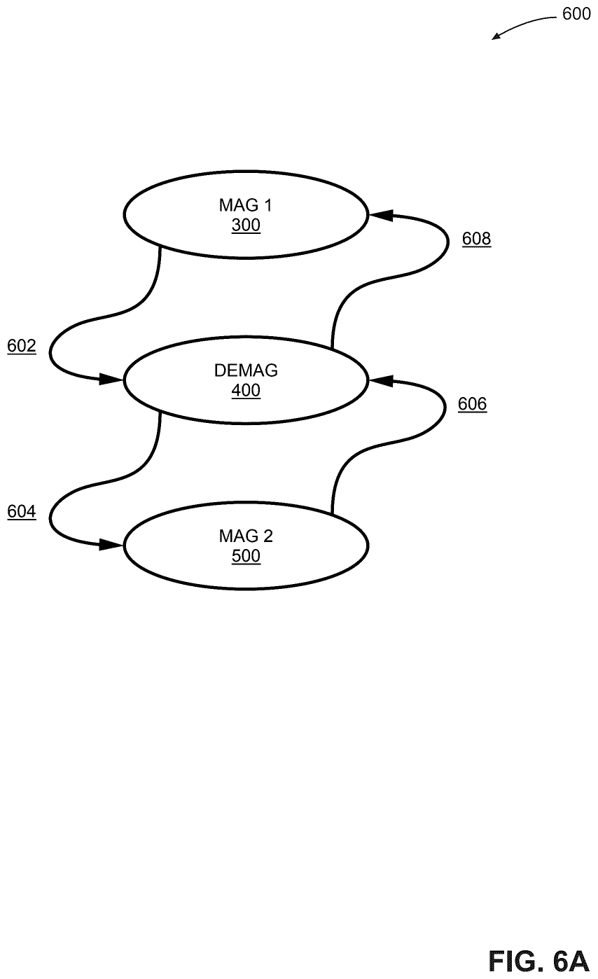

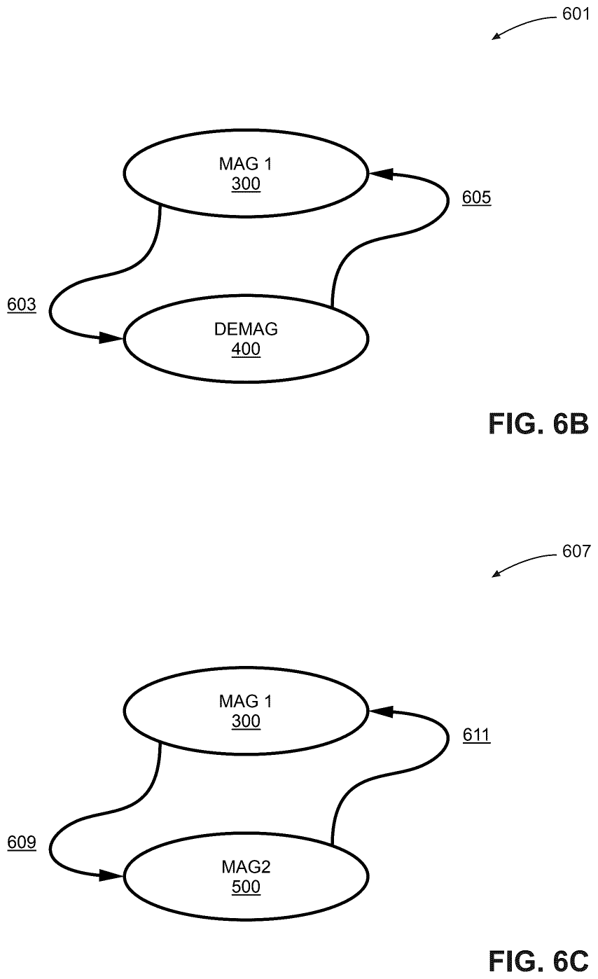

FIG. 6A is a state flow diagram 600 depicting switching system state transitions between magnetization states and a demagnetization state for hybrid DC-DC converter 100. Starting at Mag1 state 300 (State 1), the system transitions 602 to Demag state 400 (State 2). After the Demag state 400, the system transitions 604 to the Mag2 state 500 (State 3). Finally, the system transitions 606 from Mag2 state 500 to the Demag state 400 (State 4). The end of State 4 marks the end of a single switching system state cycle. After the Demag state 400 (State 4), the system transitions back 608 to the Mag1 state 300 to start a new switching system state cycle.

For proper system operation, at the end of the switching system state cycle, the voltages on the flying capacitors should be equal to the respective voltage values at the beginning of the cycle. This very critical condition, to keep the flying capacitors well balanced, is achieved by the control feedback loop. In an aspect, a switching system phase transitions to a subsequent switching system phase based on the input clock signal.

FIG. 6B is a state flow diagram 601 depicting switching system state transitions between magnetization states and a demagnetization state for hybrid DC-DC converter 100. In an alternate switching embodiment, hybrid DC-DC converter 100 can be configured to perform a DC-DC voltage conversion with two system switching states. In state flow diagram 601, starting at the Mag1 state 300, the system transitions 603 to Demag state 400. This transition concludes the two system switching state cycle. After the Demag state 400, the system transitions back 605 to the Mag1 state 300 to start a new switching system state cycle. In the switching embodiment depicted by state flow diagram 601, the switching system state sequence follows a Mag14 Demag switching system state cycle.

FIG. 6C is a state flow diagram 607 depicting switching system state transitions between magnetization states and a demagnetization state for hybrid DC-DC converter 100. In an alternate switching embodiment, hybrid DC-DC converter 100 can be configured to perform a DC-DC voltage conversion with two system switching states. In state flow diagram 607, starting at the Mag1 state 300, the system transitions 609 to the Mag2 state 500. This transition concludes the two system switching state cycle. After the Mag2 state 500, the system transitions back 611 to the Mag1 state 300 to start a new switching system state cycle. In the switching embodiment depicted by state flow diagram 607, the switching system state sequence follows a Mag1→Mag2 switching system state cycle.

There are three reasons such a hybrid architecture of hybrid DC-DC converter offers an increased efficiency versus other topologies:

Because V_{LX}=(Vᵢₙ−2Vₒᵤₜ) during magnetization, the inductor has a low current ripple, and core losses are very low. In contrast, a buck converter has V_{LX}=Vᵢₙ−Vₒᵤₜ. As a result of this, the buck converter is associated with more ripple current and more core losses on the inductor than the hybrid DC-DC converter embodiments described herein.

Direct current resistance (DCR) losses on the inductor are proportional to I_{L}². Unlike a buck converter where, I_{L}=I_{LOAD}, the hybrid DC-DC converter 100 includes a smart switching sequence that enables hybrid DC-DC converter 100 to supply the current to the load via two paths: through the inductor, and directly to Vₒᵤₜ while bypassing the inductor. Lowering the inductor current reduces the DCR losses compared with a buck converter.

There are other advantages offered by such a topology:
It allows the use of low-voltage FETs as switching transistors for high voltage input.
The circuit topology allows the circuit to be scaled to an arbitrary division coefficient, n. This might be necessary either when the input voltage is higher or when a lower voltage on the switching node (V_{SW}=(Vᵢₙ−n*Vₒᵤₜ)) is needed. This adjustment of the schematic can be done just by inserting more FETs in the top section of the circuit associated with hybrid DC-DC converter 100, as described subsequently. The advantage of keeping the switching (SW) node at low voltage (Vᵢₙ−n*Vₒᵤₜ) is still maintained with all the advantages discussed herein.

The functionality of the schematic from FIG. 1 is limited to relatively high voltages, e.g., Vᵢₙ>3Vₒᵤₜ. There are three ways to extend the functionality of this schematic by making adjustments/modifications to the circuit topology of hybrid DC-DC converter 100:

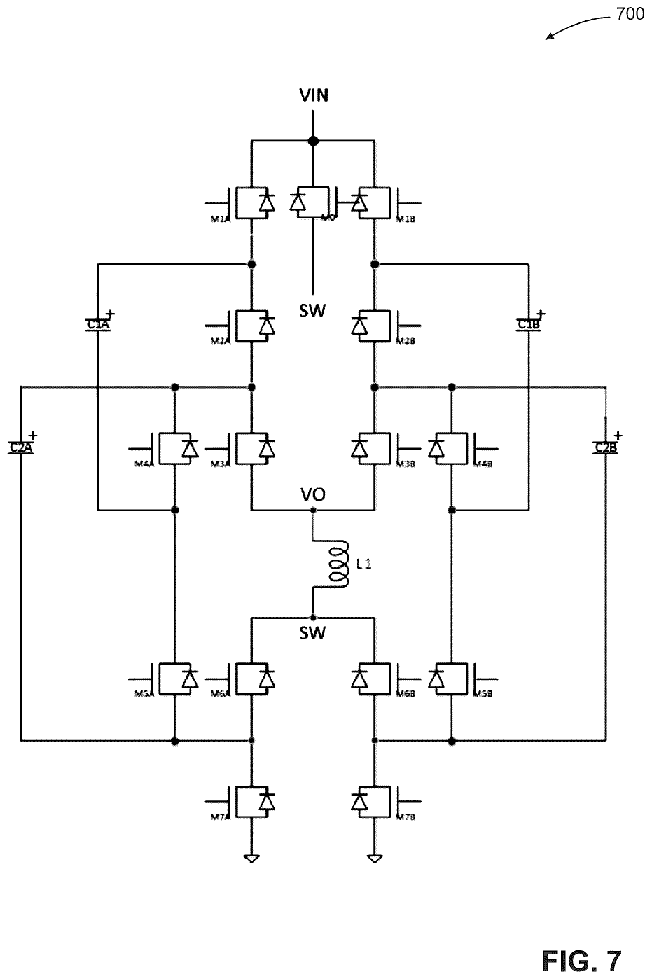

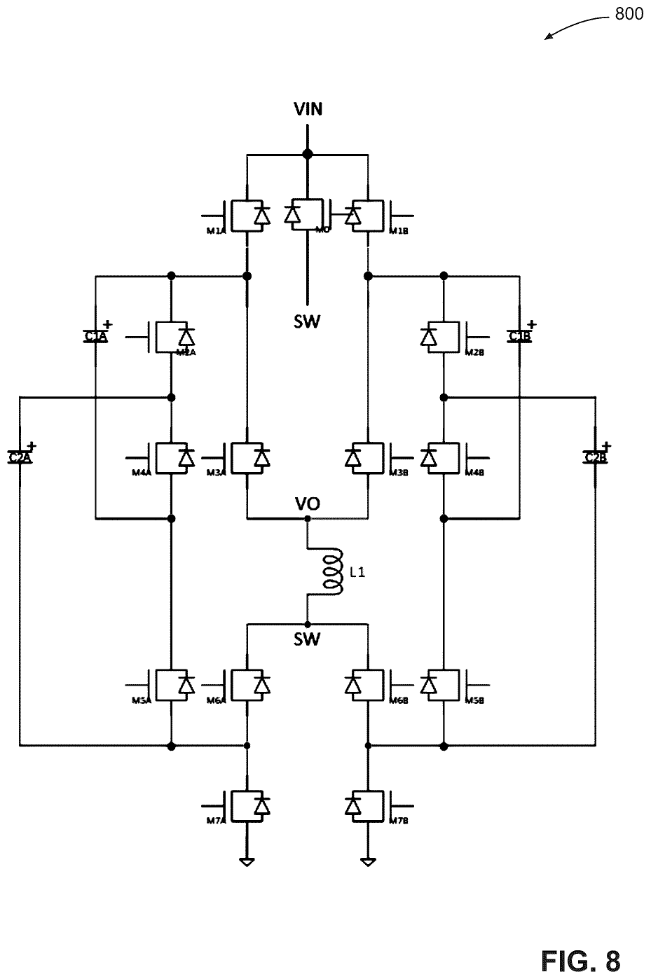

A) Scaling down the input voltage, from Vᵢₙ>3Vₒᵤₜ to Vᵢₙ>Vₒᵤₜ. Examples of such circuit topologies are presented in FIGS. 7 and 8.

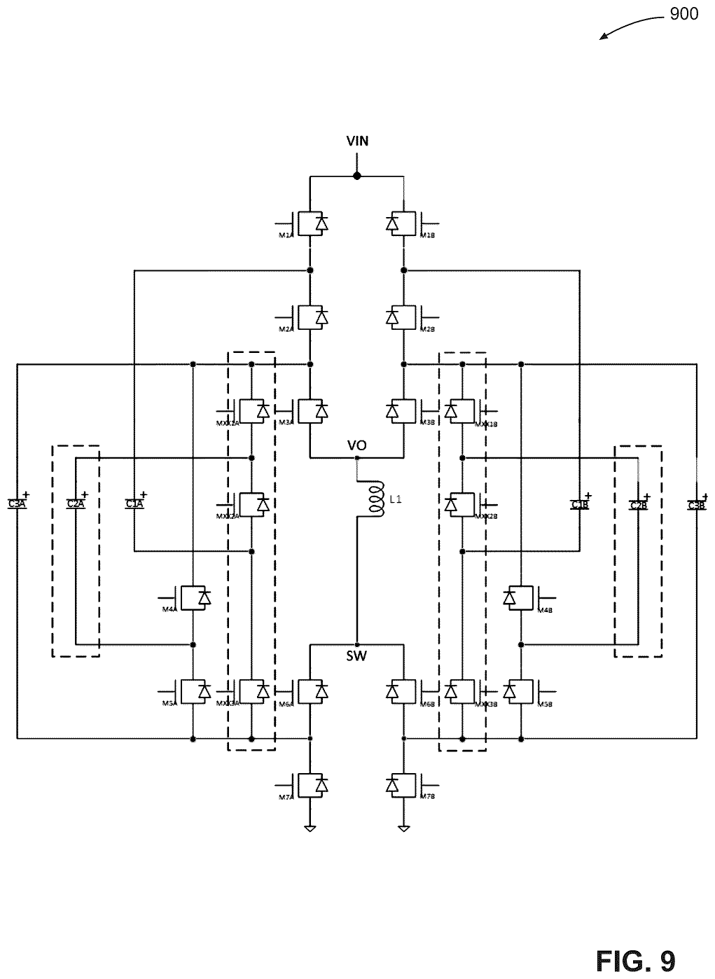

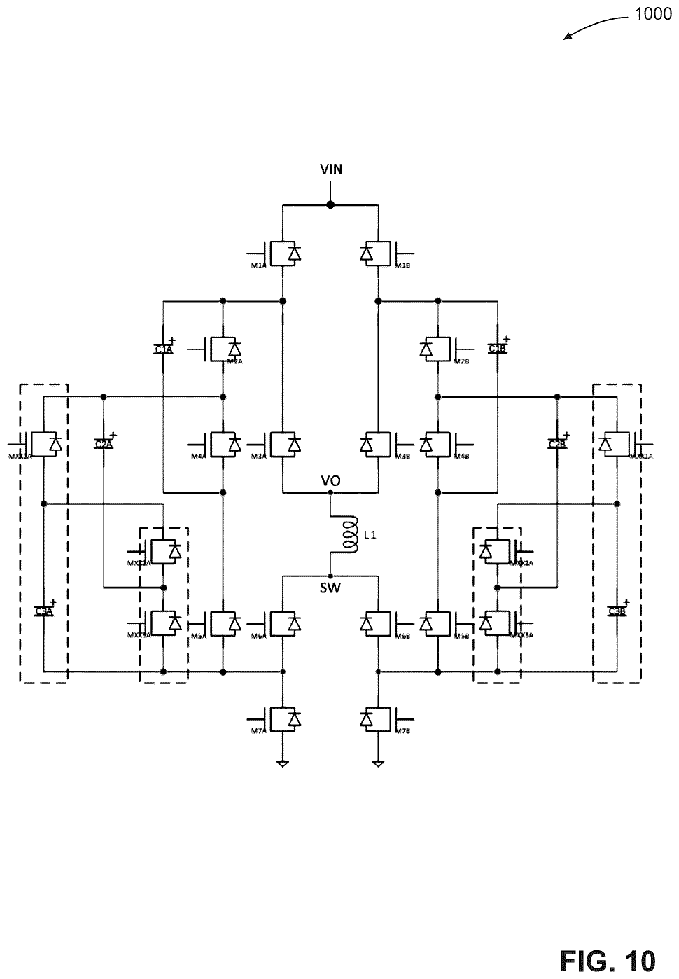

B) Scaling up the input voltage, from Vᵢₙ>3Vₒᵤₜ to an even higher Vᵢₙ>nVₒᵤₜ. can be done with another extension of the circuit topology associated with hybrid DC-DC converter 100. An example embodiment of such a topology is shown in FIGS. 9 and 10 for any value n>3. It includes 2(n−1) flying capacitors and 2+6(n−1) switching transistors (e.g., FETs). For n=3, the topology reduces to that of hybrid DC-DC converter 100.

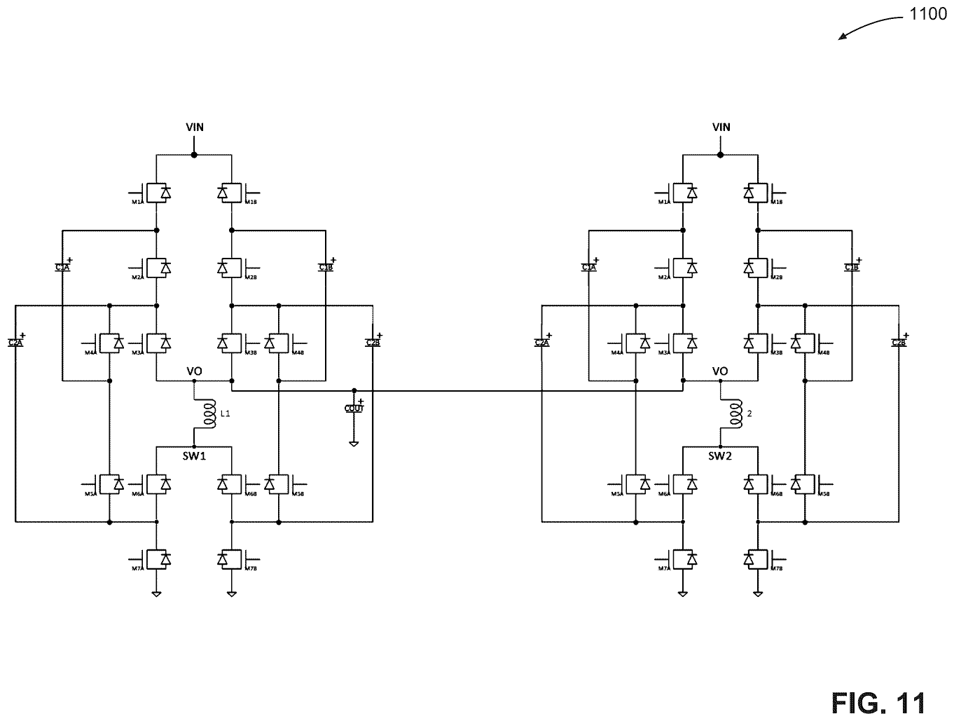

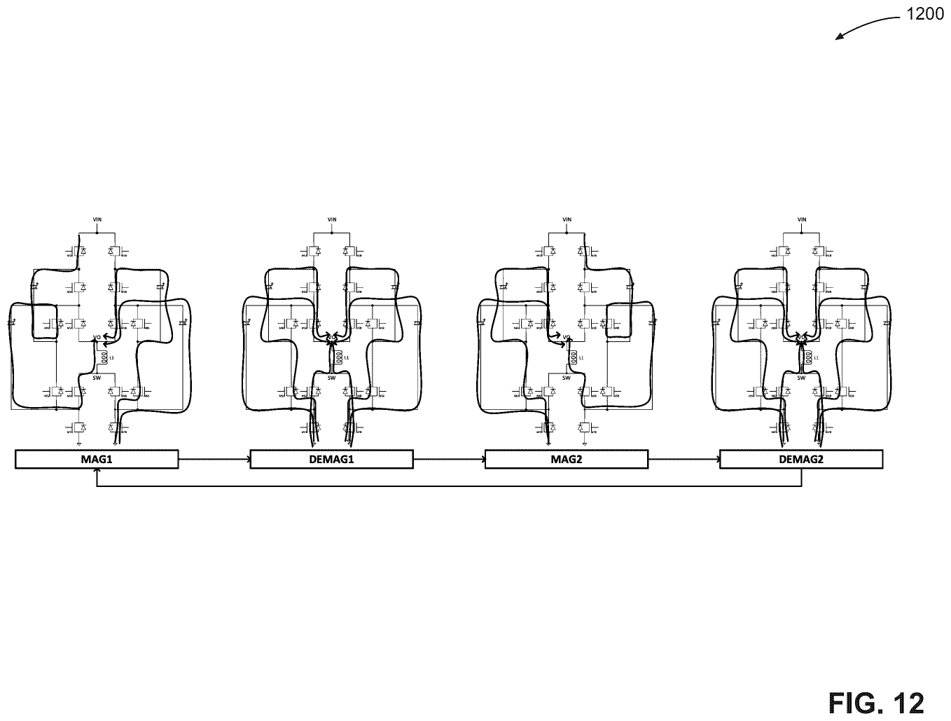

C) Scaling up the output current needed by an artificial intelligence (AI) chip, as shown in FIG. 11.

FIG. 7 is a circuit diagram of a hybrid DC-DC converter 700. Hybrid DC-DC converter 700 is a variation of hybrid DC-DC converter 100, realized by adding additional (e.g., 1-4) switching transistors to the circuit topology of hybrid DC-DC converter 100.

FIG. 8 is a circuit diagram of a hybrid DC-DC converter 800. Hybrid DC-DC converter 800 is a variation of hybrid DC-DC converter 100, realized by adding additional (e.g., 1-4) switching transistors to the circuit topology of hybrid DC-DC converter 100, and modifying the circuit topology of hybrid DC-DC converter 100 with respect to switching transistors M2A and M2B.

In the hybrid DC-DC converters 700 and 800, the slight increase in the complexity leaves the voltages of flying capacitors unchanged for the wide Vᵢₙ range. This is particularly important when the Vᵢₙ changes by flying between Vᵢₙ˜Vₒᵤₜ and Vᵢₙ>3Vₒᵤₜ. Other hybrid topologies need a change in flying capacitor pre-bias voltages to work properly. However, different switching sequences over a cycle (similar to the circuit embodiments described herein for Vᵢₙ≥3Vₒᵤₜ), should be applied for each of the ranges 3Vₒᵤₜ≥Vᵢₙ≥2Vₒᵤₜ, 2Vₒᵤₜ≥Vᵢₙ≥1Vₒᵤₜ, and Vᵢₙ>Vₒᵤₜ, respectively. This extended dynamic mode of operation from Vᵢₙ>Vₒᵤₜ up to Vᵢₙ>3Vₒᵤₜ with high power efficiency makes the hybrid DC-DC converters 700 and 800 extremely useful.

FIG. 9 is a circuit diagram of a hybrid DC-DC converter 900. As shown in FIG. 9, hybrid DC-DC converter 900 is realized by adding additional switching transistors and flying capacitors to the circuit topology of hybrid DC-DC converter 100.

FIG. 10 is a circuit diagram of a hybrid DC-DC converter 1000. As shown in FIG. 10, hybrid DC-DC converter 1000 is realized by adding additional switching transistors and flying capacitors to the circuit topology of hybrid DC-DC converter 100.

Hybrid DC-DC converter topologies 900 and 1000 are configured to implement scaling up the input voltage, from Vᵢₙ>3Vₒᵤₜ to an even higher Vᵢₙ≥n*Vₒᵤₜ, as described previously.

FIG. 11 is a circuit diagram depicting a pair of parallel-connected hybrid DC-DC converters 1100. In an aspect, if higher load current capacity is required, multiple circuits of hybrid DC-DC converter 100 may be connected in parallel. For example parallel connection 1100 includes two instances of hybrid DC-DC converter 100 connected in a parallel configuration. In one aspect, multiple such instances of hybrid DC-DC converter 100 can be parallel-connected as needed. Such a multi-phase system has the same input Vᵢₙ and the same output Vₒᵤₜ. The overall current will be the sum of the current generated by each phase. In alternative embodiments, the parallel connection can be comprised of circuits that include hybrid DC-DC converter configurations 700-1000.

FIG. 12 is a state flow diagram 1200 depicting switching system state transitions associated with an operation of hybrid DC-DC converter 100. In an aspect, state flow diagram 1200 depicts a sequence of switching states when the input and output voltages are related as Vᵢₙ≥3Vₒᵤₜ. State flow diagram 1200 depicts electric current paths through the circuit of hybrid DC-DC converter 100 to implement a four-switching system state control strategy for the mode of operation Vᵢₙ≥3Vₒᵤₜ. As depicted, the switching system state control strategy for this mode of operation includes four switching system states—Mag1, Demag1, Mag2, and Demag2. This sequence of switching system states is similar to that presented in state flow diagram 600. In this mode of operation, hybrid DC-DC converter 100 may operate with the following variations:
Path M2A+M3A+C1A+M5A+M7A can be adjusted to be used in one of the three states for DEMAG1, DEMAG2, or MAG2.
Path M2A+M3A+C1A+M5A+M7A can be adjusted to be used in two of the three states for DEMAG1, DEMAG2, or MAG2.
Path M2A+M3A+C1A+M5A+M7A can be adjusted to be used in all three states for DEMAG1, DEMAG2, or MAG2.
Path M2B+M3B+C1B+M5B+M7B can be adjusted to be used in one of the three states for DEMAG1, DEMAG2, or MAG1.
Path M2B+M3B+C1B+M5B+M7B can be adjusted to be used in two of the three states for DEMAG1, DEMAG2, or MAG1.
Path M2B+M3B+C1B+M5B+M7B can be adjusted to be used in all three states for DEMAG1, DEMAG2, or MAG1.
Path M3A+C2A+M7A can be adjusted to be used in one of the three states for DEMAG1, DEMAG2, or MAG2.
Path M3A+C2A+M7A can be adjusted to be used in two of the three states for DEMAG1, DEMAG2, or MAG2.
Path M3A+C2A+M7A can be adjusted to be used in all three states for DEMAG1, DEMAG2, or MAG2.
Path M3B+C2B+M7B can be adjusted to be used in one of the three states for DEMAG1, DEMAG2, or MAG1.
Path M3B+C2B+M7B can be adjusted to be used in two of the three states for DEMAG1, DEMAG2, or MAG1.
Path M3B+C2B+M7B can be adjusted to be used in all three states for DEMAG1, DEMAG2, or MAG1.
Path M6A+M7A+L can be adjusted for one of the two states for DEMAG1 or DEMAG2.
Path M6A+M7A+L can be adjusted to be used in both states for DEMAG1 or DEMAG2.
Path M6A+M7A+L can be removed if Path M6B+M7B+L exists in the state
Path M6B+M7B+L can be adjusted to be used in one of the two states for DEMAG1 or DEMAG2.
Path M6B+M7B+L can be adjusted to be used in both states for DEMAG1 or DEMAG2.
Path M6B+M7B+L can be removed if Path M6A+M7A+L exists in the state.

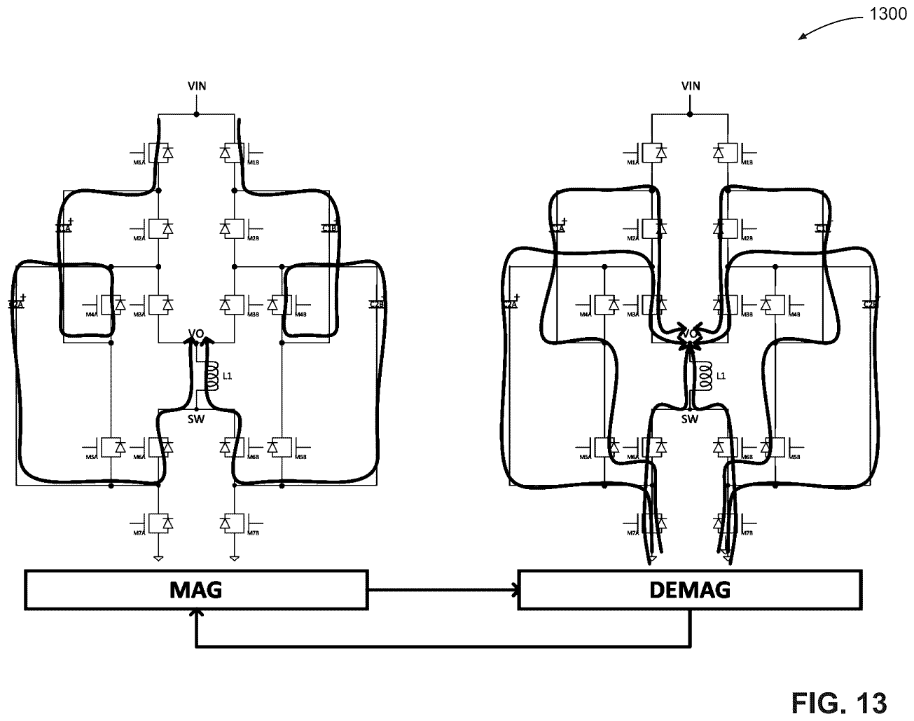

FIG. 13 is a state flow diagram 1300 depicting switching system state transitions associated with an operation of hybrid DC-DC converter 100. State flow diagram 1300 depicts electric current paths through the circuit of hybrid DC-DC converter 100 to implement a two-switching system state control strategy for the mode of operation Vᵢₙ≥3Vₒᵤₜ. As depicted, the switching system state control strategy for this mode of operation includes a magnetization state and a demagnetization state. The switching system state control strategy associated with state flow diagram 1300 may be used as an alternative to the switching system state control strategy associated with state flow diagram 1200. This sequence of switching system states is similar to that presented in state flow diagram 601.

In an alternative embodiment, the Demag state in state flow diagram 1300 may be replaced by the Mag 2 state for hybrid DC-DC converter 100 by an alternative switching scheme, to implement a two switching system state operation (not depicted herein, but characterized by state flow diagram 609). This alternate embodiment can be used to implement an operational mode where Vᵢₙ is close to 3Vₒᵤₜ.

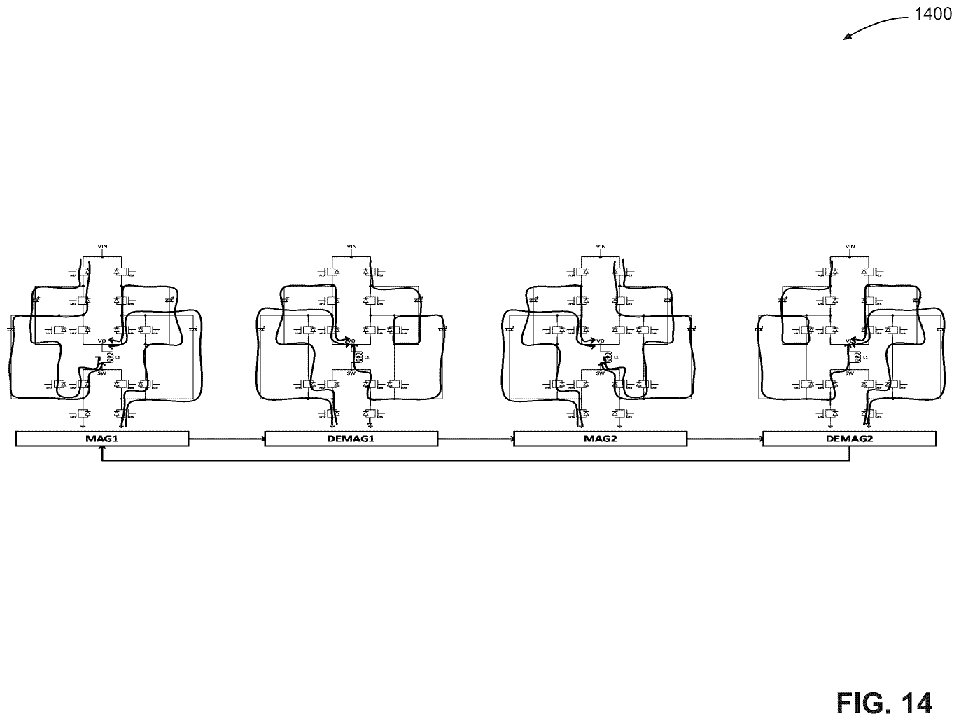

FIG. 14 is a state flow diagram 1400 depicting switching system state transitions associated with an operation of hybrid DC-DC converter 100. In an aspect, state flow diagram 1400 depicts a sequence of switching states when the input and output voltages are related as 3Vₒᵤₜ>Vᵢₙ>2Vₒᵤₜ. State flow diagram 1300 depicts electric current paths through the circuit of hybrid DC-DC converter 100 to implement a four-switching system state control strategy for the mode of operation 3Vₒᵤₜ>Vᵢₙ>2Vₒᵤₜ. As depicted, the switching system state control strategy for this mode of operation includes four switching system states—Mag1, Demag1, Mag2, and Demag2. This sequence of switching system states is similar to that presented in state flow diagram 600, but with different current paths through the circuit for each switching system state as compared to state flow diagram 1200. In this mode of operation, hybrid DC-DC converter 100 may operate with the following variations:
Path M2A+M3A+C1A+M5A+M7A can be adjusted to be used in one of the two states for DEMAG1, or MAG2.
Path M2A+M3A+C1A+M5A+M7A can be adjusted to be used in both states for DEMAG1, or MAG2.
Path M2B+M3B+C1B+M5B+M7B can be adjusted to be used in one of the two states for MAG1, or DEMAG2.
Path M2B+M3B+C1B+M5B+M7B can be adjusted to be used in both states for MAG1, or DEMAG2.
Path M3A+C2A+M7A can be adjusted to be used in one of the two states for DEMAG1, or MAG2.
Path M3A+C2A+M7A can be adjusted to be used in both states for DEMAG1, or MAG2.
Path M3B+C2B+M7B can be adjusted to be used in one of the two states for MAG1, or DEMAG2.
Path M3B+C2B+M7B can be adjusted to be used in both states for MAG1, or DEMAG2.
Path M1A+C1A+M5A+M6A+L can be removed if Path M1A+M2A+C2A+M6A+L exists in the state.
Path M1A+C2A+M2A+M6A+L can be removed if Path M1A+M5A+C1A+M6A+L exists in the state.
Path M1B+C1B+M5B+M6B+L can be removed if Path M1B+M2B+C2B+M6B+L exists in the state.
Path M1B+C2B+M2B+M6B+L can be removed if Path M1B+M5B+C1B+M6B+L exists in the state.

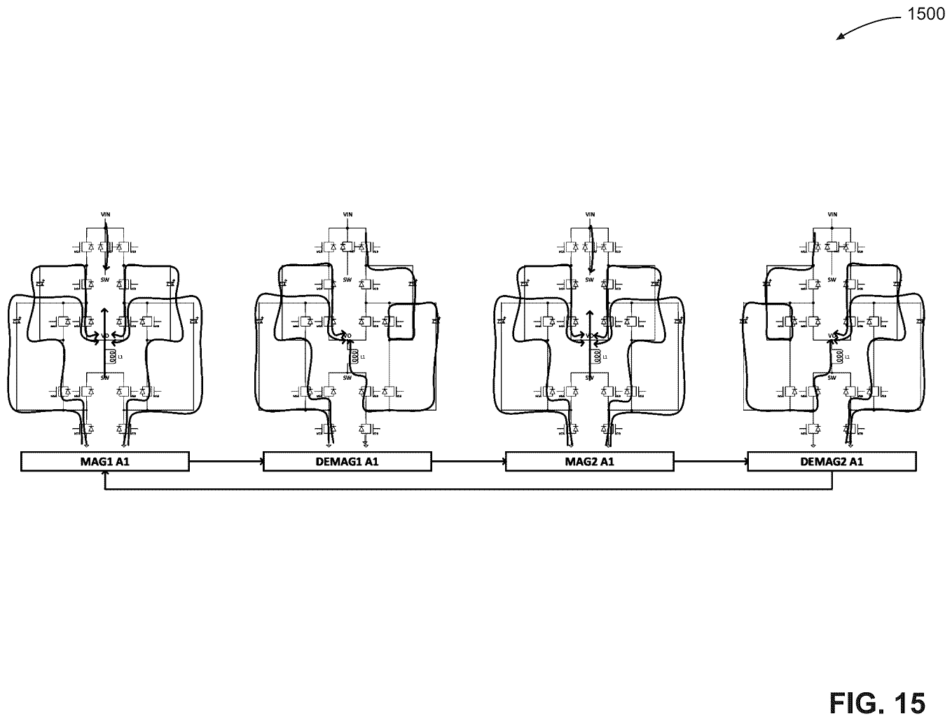

FIG. 15 is a state flow diagram 1500 depicting switching system state transitions associated with an operation of hybrid DC-DC converter 700. In another aspect, these switching system state transitions can also be applied to hybrid DC-DC converter 800. In an aspect, state flow diagram 1500 depicts a sequence of switching states when the input and output voltages are related as 3Vₒᵤₜ>Vᵢₙ>Vₒᵤₜ. State flow diagram 1500 depicts electric current paths through the circuit of hybrid DC-DC converter 700 to implement a four-switching system state control strategy for the mode of operation 3Vₒᵤₜ>Vᵢₙ>Vₒᵤₜ. As depicted, the switching system state control strategy for this mode of operation includes four switching system states—Mag1 A1, Demag1 A1, Mag2 A1, and Demag2 A1. In this mode of operation, hybrid DC-DC converter 700 may operate with the following variations (the MAG and DEMAG states described below do not include the “A1” for clarity):
Path M2A+M3A+C1A+M5A+M7A can be adjusted to be used in one of the three states for MAG1, MAG2, or DEMAG1.
Path M2A+M3A+C1A+M5A+M7A can be adjusted to be used in two of the three states for MAG1, MAG2, or DEMAG1.
Path M2A+M3A+C1A+M5A+M7A can be adjusted to be used in all three states for MAG1, MAG2, or DEMAG1.
Path M2B+M3B+C1B+M5B+M7B can be adjusted to be used in one of the three states for MAG1, MAG2, or DEMAG2.
Path M2B+M3B+C1B+M5B+M7B can be adjusted to be used in two of the three states for MAG1, MAG2, or DEMAG2.
Path M2B+M3B+C1B+M5B+M7B can be adjusted to be used in all three states for MAG1, MAG2, or DEMAG2.
Path M3A+C2A+M7A can be adjusted to be used in one of the three states for MAG1, MAG2, or DEMAG1.
Path M3A+C2A+M7A can be adjusted to be used in two of the three states for MAG1, MAG2, or DEMAG1.
Path M3A+C2A+M7A can be adjusted to be used in all three states for MAG1, MAG2, or DEMAG1.
Path M3B+C2B+M7B can be adjusted to be used in one of the three states for MAG1, MAG2, or DEMAG2.
Path M3B+C2B+M7B can be adjusted to be used in two of the three states for MAG1, MAG2, or DEMAG2.
Path M3B+C2B+M7B can be adjusted to be used in all three states for MAG1, MAG2, or DEMAG2.

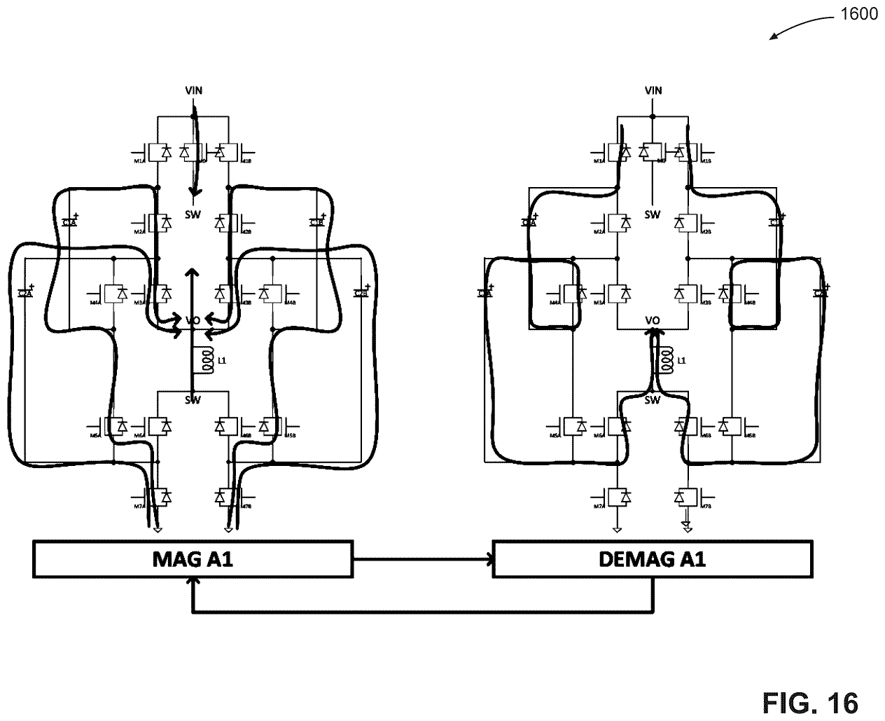

FIG. 16 is a state flow diagram 1600 depicting switching system state transitions associated with an operation of hybrid DC-DC converter 700. In another aspect, these switching system state transitions can also be applied to hybrid DC-DC converter 800. State flow diagram 1600 depicts electric current paths through the circuit of hybrid DC-DC converter 700 to implement a two-switching system state control strategy for the mode of operation 3Vₒᵤₜ>Vᵢₙ>Vₒᵤₜ. As depicted, the switching system state control strategy for this mode of operation includes a magnetization state and a demagnetization state. The switching system state control strategy associated with state flow diagram 1600 may be used as an alternative to the switching system state control strategy associated with state flow diagram 1500.

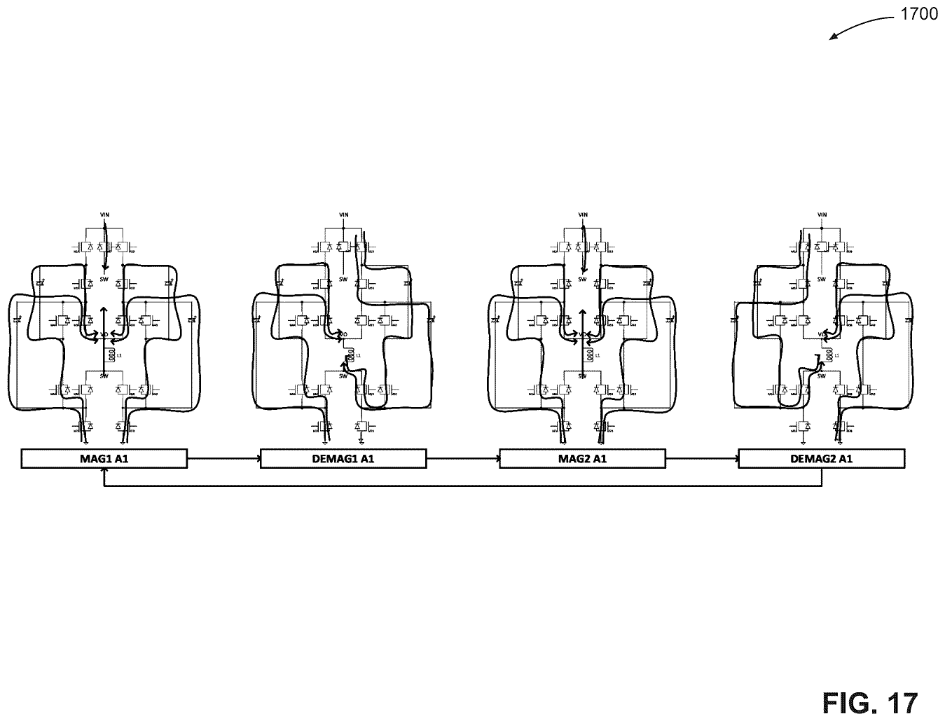

FIG. 17 is a state flow diagram 1700 depicting switching system state transitions associated with an operation of hybrid DC-DC converter 700. In another aspect, these switching system state transitions can also be applied to hybrid DC-DC converter 800. In an aspect, state flow diagram 1500 depicts a sequence of switching states when the input and output voltages are related as 2Vₒᵤₜ>Vᵢₙ>Vₒᵤₜ. State flow diagram 1700 depicts electric current paths through the circuit of hybrid DC-DC converter 700 to implement a four-switching system state control strategy for the mode of operation 2Vₒᵤₜ>Vᵢₙ>Vₒᵤₜ As depicted, the switching system state control strategy for this mode of operation includes four switching system states—Mag1 A1, Demag1 A1, Mag2 A1, and Demag2 A1. In this mode of operation, hybrid DC-DC converter 700 may operate with the following variations (the MAG and DEMAG states described below do not include the “A1” for clarity):
Path M2A+M3A+C1A+M5A+M7A can be adjusted to be used in one of the three states for DEMAG1, MAG1, or MAG2.
Path M2A+M3A+C1A+M5A+M7A can be adjusted to be used in two of the three states for DEMAG1, MAG1, or MAG2.
Path M2A+M3A+C1A+M5A+M7A can be adjusted to be used in all states for DEMAG1, MAG1, or MAG2.
Path M2B+M3B+C1B+M5B+M7B can be adjusted to be used in one of the three states for DEMAG2, MAG1, or MAG2.
Path M2B+M3B+C1B+M5B+M7B can be adjusted to be used in two of the three states for DEMAG2, MAG1, or MAG2.
Path M2B+M3B+C1B+M5B+M7B can be adjusted to be used in all states for DEMAG2, MAG1, or MAG2.
Path M3A+C2A+M7A can be adjusted to be used in one of the three states for DEMAG1, MAG1, or MAG2.
Path M3A+C2A+M7A can be adjusted to be used in two of the three states for DEMAG1, MAG1, or MAG2.
Path M3A+C2A+M7A can be adjusted to be used in all states for DEMAG1, MAG1, or MAG2.
Path M3B+C2B+M7B can be adjusted to be used in one of the three states for DEMAG2, MAG1, or MAG2.
Path M3B+C2B+M7B can be adjusted to be used in two of the three states for DEMAG2, MAG1, or MAG2.
Path M3B+C2B+M7B can be adjusted to be used in all states for DEMAG2, MAG1, or MAG2.
Path M1A+C1A+M5A+M6A+L can be removed if Path M1A+M2A+C2A+M6A+L exists in the state.
Path M1A+C2A+M2A+M6A+L can be removed if Path M1A+M5A+C1A+M6A+L exists in the state.
Path M1B+C1B+M5B+M6B+L can be removed if Path M1B+M2B+C2B+M6B+L exists in the state.
Path M1B+C2B+M2B+M6B+L can be removed if Path M1B+M5B+C1B+M6B+L exists in the state.

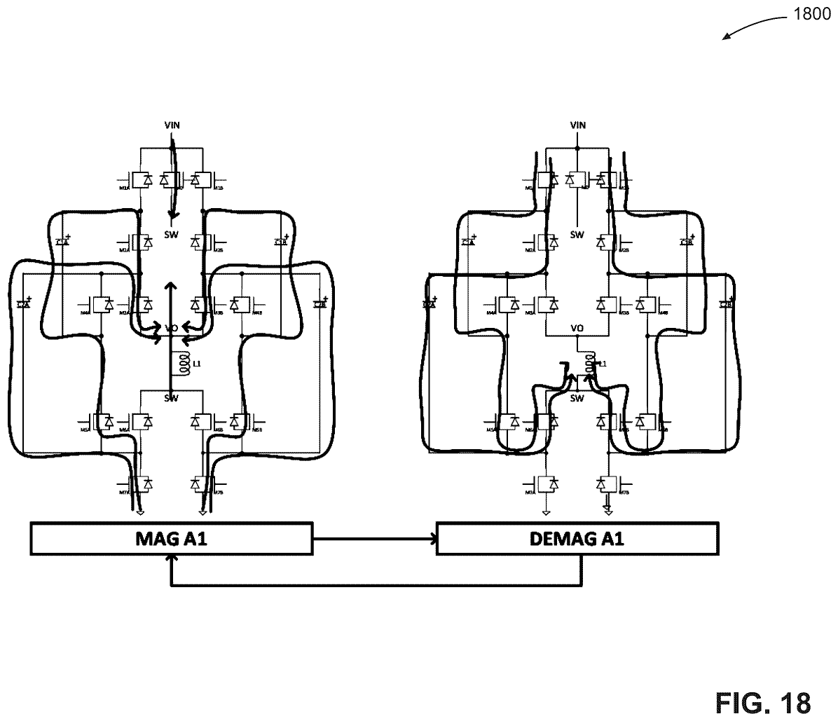

FIG. 18 is a state flow diagram 1800 depicting switching system state transitions associated with an operation of hybrid DC-DC converter 700. In another aspect, these switching system state transitions can also be applied to hybrid DC-DC converter 800. State flow diagram 1800 depicts electric current paths through the circuit of hybrid DC-DC converter 700 to implement a two-switching system state control strategy for the mode of operation 2Vₒᵤₜ>Vᵢₙ>Vₒᵤₜ. As depicted, the switching system state control strategy for this mode of operation includes a magnetization state and a demagnetization state. The switching system state control strategy associated with state flow diagram 1800 may be used as an alternative to the switching system state control strategy associated with state flow diagram 1700.

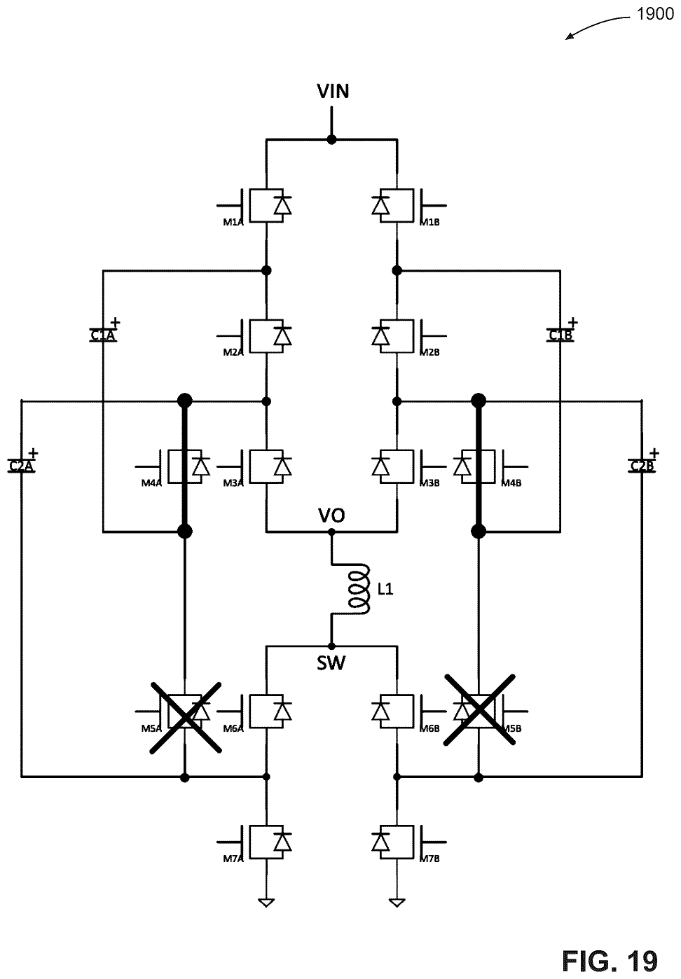

FIG. 19 is a circuit diagram of a hybrid DC-DC converter 1900. As depicted, hybrid DC-DC converter is a variant/modification of hybrid DC-DC converter 100, where switching transistors M4A and M4B are permanently switched on. Hence, switching transistors M4A and M4B are replaced by wires in the circuit topology of hybrid DC-DC converter 1900. Also, switching transistors M5A and M5B are permanently switched off in hybrid DC-DC converter 1900 as a part of the modification to hybrid DC-DC converter 100. Hence, these switching transistors are replaced by open circuit connections. The circuit topology of hybrid DC-DC converter 1900 enables a scaling down of the input voltage, Vn.

Although the present disclosure is described in terms of certain example embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

What is claimed is:

1. An electrical circuit configured to perform a DC-DC voltage conversion between an input voltage Vᵢₙ and an output voltage Vₒᵤₜ, the electrical circuit comprising:
a first electrical network including seven switching transistors and two flying capacitors;
a second electrical network including seven switching transistors and two flying capacitors, wherein the first electrical network and the second electrical network are interconnected at least at each of an input node associated with the input voltage, an output node associated with the output voltage, and a switching node; and
an inductor connected between the switching node and the output node, wherein the DC-DC voltage conversion involves a repeated cycle of four distinct switching system states, and wherein each switching system state is associated with a distinct electric current path through the electrical circuit.

2. The electrical circuit of claim 1, wherein:
the inductor is included in a current path from the input node to the output node;
a direct path between the input node and the output node exists that includes only one or more switching transistors and no other circuit component;
any current path between the input node and the switching node includes at least one flying capacitor; and
there is at least one switching transistor connected directly to the output node.

3. The electrical circuit of claim 1, wherein the four distinct switching system states are comprised of a first magnetization system state, a demagnetization system state, a second magnetization system state, and the demagnetization system state.

4. The electrical circuit of claim 1, wherein at an end of the fourth switching system state, a voltage on each flying capacitor is substantially equal to a voltage on the flying capacitor at a beginning of the first system state.

5. The electrical circuit of claim 4, wherein the equality is established by a feedback control circuit.

6. The electrical circuit of claim 1, wherein each system state is associated with a combination of each of the switching transistors being either in an on state or an off state.

7. The electrical circuit of claim 1, wherein the input voltage and the output voltage are related as Vᵢₙ≥3Vₒᵤₜ.

8. The electrical circuit of claim 1, wherein the input voltage and the output voltage are related as 3Vₒᵤₜ>Vᵢₙ>2Vₒᵤₜ.

9. The electrical circuit of claim 1, further comprising a parallel connection of a plurality of electrical circuits to provide a modified electrical circuit configured to further provide a higher electric current to a load as compared an electric current provided by the electrical circuit.

10. The electrical circuit of claim 1, wherein a transition between any switching system state and a subsequent switching system state is governed by a clock signal.

11. The electrical circuit of claim 1, further comprising a modified electrical circuit that includes at least one switching transistor added to the electrical circuit.

12. The modified electrical circuit of claim 11, wherein the input voltage and the output voltage are related as 3Vₒᵤₜ>Vᵢₙ>Vₒᵤₜ.

13. The modified electrical circuit of claim 11, wherein the four switching states are a first magnetization state, a first demagnetization state, a second magnetization state, and a second demagnetization state.

14. The modified electrical circuit of claim 11, wherein the DC-DC voltage conversion involves a modified repeated cycle of two distinct switching system states.

15. The modified electrical circuit of claim 11, wherein the modified repeated cycle includes a magnetization state and a demagnetization state.

16. An electrical circuit configured to perform a DC-DC voltage conversion between an input voltage Vᵢₙ and an output voltage Vₒᵤₜ, the electrical circuit comprising:
a first electrical network including seven switching transistors and two flying capacitors;
a second electrical network including seven switching transistors and two flying capacitors, wherein the first electrical network and the second electrical network are interconnected at least at each of an input node associated with the input voltage, an output node associated with the output voltage, and a switching node; and
an inductor connected between the switching node and the output node, wherein the DC-DC voltage conversion involves a repeated cycle of two distinct switching system states, and wherein each switching system state is associated with a distinct electric current path through the electrical circuit.

17. The electrical circuit of claim 16, wherein the switching states are a magnetization state and a demagnetization state.

18. The electrical circuit of claim 16, wherein the switching states are a first magnetization state and a second magnetization state.

19. The electrical circuit of claim 16, further comprising a modified electrical circuit that includes at least one switching transistor added to the electrical circuit.

20. The modified electrical circuit of claim 19, wherein the repeated cycle includes a magnetization state and a demagnetization state.

21. The electrical circuit of claim 16, wherein at an end of the second switching system state, a voltage on each flying capacitor is substantially equal to a voltage on the flying capacitor at a beginning of the first system state.
